(19) United States
(12) Patent Application Publication
(10) Pub. No.: US 2006/0158878 A1
(43) Pub. Date: Jul. 20, 2006

(54) Retractable light apparatus

(76) Inventor: Byron H. Howell, East St. Louis, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/336,003

(22) Filed: Jan. 20, 2006

Related U.S. Application Data
(60) Provisional application No. 60/645,129, filed on Jan. 20, 2005.

(51) Int. Cl. F21S 4/00

(52) U.S. Cl. 362/223

(57) ABSTRACT

A retractable light apparatus includes a plug for receiving electrical power, a helical coil that can elongate and retract to its original shape when released, and decorative lights affixed to the helical coil.

### CROSS-REFERENCE TO RELATED APPLICATIONS

This application claims the benefit of United States Provisional Application 60/645,129, filed Jan. 20, 2005, which is incorporated by reference herein.

### STATEMENT REGARDING FEDERALLY SPONSORED RESEARCH

Not Applicable

### BACKGROUND OF THE INVENTION

This invention relates to devices for retracting strings of decorative lights. Strings of decorative lights are a common sight during holidays and other special occasions. Typically, they are only used for short periods of time until they are taken down and packed away for storage. However, packing and storing strings of decorative lights can be a cumbersome and frustrating experience. Repacking lights in their original packing, even if successful, is extremely time-consuming. Other methods of storage, such as reels, can be just as time-consuming and usually result in a tangled knot of lights. For some, this experience is so futile that they resort to leaving holiday lights up all year long, often to the displeasure of neighbors. As a result, there is a long felt need for strings of decorative lights that are easy to pack and store.

### BRIEF SUMMARY OF THE INVENTION

Briefly stated, the invention comprises a retractable light apparatus comprising a plug for receiving electrical power, a helical coil that can elongate and retract to its original shape, and at least one strand of decorative lights affixed to the helical coil.

### BRIEF DESCRIPTION OF THE SEVERAL VIEWS OF THE DRAWINGS

In the accompanying drawings which form part of the specification:

FIG. 1 is a perspective view of a first embodiment of a retractable light apparatus in a relaxed, retracted position.

FIG. 2 is a view in side elevation of a spring coil portion of the apparatus of FIG. 1.

FIG. 3 is a perspective view of a portion of the apparatus of FIG. 1 in a partially extended position.

FIG. 4 is a perspective view of a second embodiment of a retractable light apparatus.

FIG. 5 is a perspective view of a third embodiment of a retractable light apparatus.

FIG. 6 is a perspective view of a fourth embodiment of a retractable light apparatus.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

As shown in FIG. 1, a first embodiment of a retractable light apparatus 1 comprises a helical coil 3, a string of decorative lights 5, and a plug 7.

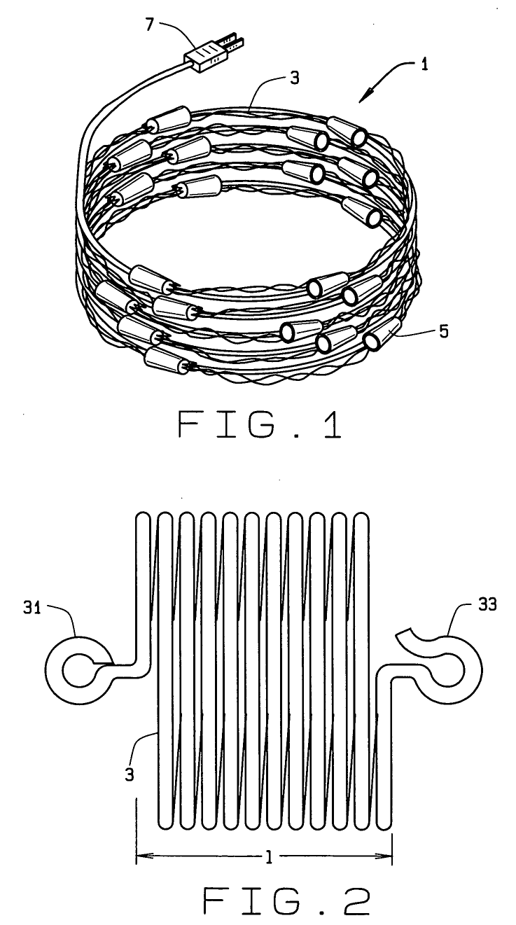

The helical coil 3 is flexible and can repeatedly elongate and retract from a stretched elongated position to a relaxed retracted position, where it is compressed in a tightly wound helical coil. The natural tendency of the coil 3 is to return to a retracted position, even if the retracted coil becomes somewhat elongated with use. By way of example, the coil 3 may be formed of about sixteen feet (5 m) of 0.0937″ (2.38 mm) diameter spring steel which, in the absence of the lights 5, retracts to a coil having diameter of about four inches (10 cm) and a length (“l” in FIG. 2) of about 1.5″ (4 cm), exclusive of end connectors. Although the coil 3 could be pulled to nearly its full straightened extent, it is preferred to pull it only to about half its maximum length, or about eight feet (2.5 m), in order to provide a particularly attractive helical appearance to the lights. It will be understood that coils having a fully extended length of from about four feet to about sixty feet (about 1.2-18 m) and a relaxed coil diameter of about two to about ten inches (about 5-25 cm) are presently preferred. The diameter of the wire will depend not only on the length of the coils, but also on the material of which the coil is made, and may vary widely in accordance with well-known principles.

The lights 5 affix along the helical coil 3 so that they elongate and retract along with the coil 3. The lights 5 preferably include bulbs 51 in sockets 55 connected by electrical wiring 53. The bulbs 51 may be any decorative lights that can be electrically connected in series or in parallel. Miniature, C7, C9, and rope lights are presently popular lights. Lights of the type generally known as miniature Christmas lights are presently preferred. Variations of miniature lights include those grouped as icicle, garland, and cluster lights; the lights are presently generally incandescent, but LED versions are also known and may be utilized. The lights may also be configured as twinkle or chasing lights. The lights may preferably be connected in strands of from ten to four hundred lights. The lights are preferably spaced from one to eight inches apart, more preferably from one to four inches apart. The lights 5 are electrically connected through a plug 7 so that electrical power can be provided; conventionally, a socket is provided at the opposite end of the strand to permit multiple strands to be plugged together.

The lights 5 are held to the coil wire 3 by clips 61. The illustrative clips 61 include the standard socket 55 for the light bulbs 51, a first clip 65 proportioned to grip the wire 3 tightly, and a second clip 67 proportioned to hold the electrical wiring 53, all molded as a single piece of plastic. It will be understood that numerous clips and ties may be used for the purpose of holding the lights 5 to the coil 3. Moreover, the lights 5 may be held to the coil wire 3 in other ways. For example, the electrical wires 53 of the string of lights 5 may simply be wound around the coil wire 3 and held by friction.

Hangers are affixed to the apparatus 1 to attach the apparatus to a support, such as a gutter, gutterboard, eave, window frame, door frame, tree, or bush. Numerous hangers are known for light strands, including hooks, nails, staples, gutter clips, siding clips, shingle tabs, ties, and adhesives. All of these are widely commercially available and are well known in the art. The patent literature also contains numerous examples, including by way of example Adams, U.S. Pat. Nos. 6,644,836, 6,328,459, and 5,772,166, Protz, Jr., U.S. Pat. Nos. 5,613,656, 5,609,415, and 5,566,058, Limber et al., U.S. Pat. Nos. 6,572,062 and 6,536,727, Hill et al, U.S. Pat. No. 6,827,379, Norberg, U.S. Pat. No. 6,663,069, Baer, U.S. Pat. No. 6,536,730, Schroetter, U.S. Pat. No. 6,494,594, Ahroni, U.S. Pat. No. 6,142,429, and LaPointe, U.S. Pat. No. 5,921,511. It is possible for the user to supply these hangers, but it is preferred that at least one hanger be provided on the coil 3. It is also preferred that a connector be provided at least at one end of the coil 3 to connect the coil to another coil. By way of example, as shown in FIG. 2, a loop 31 is formed from the wire at one end of the coil 3, and a hook 33 formed from the wire at its other end, sized to engage the loop end 31 of another coil 3. As another example, a separate hook molded of plastic may be provided having a first loop end sized to hold two coil ends, and a second loop end sized to engage a gutter. One example of such a hook is shown in Ahroni, U.S. Pat. No. 6,142,429, in which the mating slots 58a and 58b may hold the coils of successive devices 1. The hook thus functions both as a connector and as a hanger. Other connectors will be apparent to those skilled in the art, such as the connector of Adams, U.S. Pat. No. 6,328,459, modified to make d1 and d2 of that patent identical. The connector may also be formed as, or covered by, a decorative element, such as a star.

The bulk of the lights 5 will prevent the coil 3 from retracting completely. In an illustrative embodiment, the light bulbs 51 are spaced about three inches (7.5 cm) apart, the coil wire 3 is about sixteen feet (5 meters) long, and the apparatus 1 is about ten inches (25 cm) long when relaxed and about eight feet long when pulled out to a preferred (but not maximum) mounting length. It is preferred that the apparatus be at least about four times as long when pulled out as its relaxed, coiled length.

In operation, the helical coil 3 is stretched to an elongated position. Preferably, one end of the coil is attached to a support, such as a gutter or eave, by a hanger, then the coil is extended and attached to the support at a desired length. The helical configuration of the apparatus 1 allows it to be stretched to any length up to its full extension and still be held at a generally straight, uniform height. The density and width of the lighting may be varied by the distance the coil is stretched. In the extended position, the apparatus 1 can be hung anywhere decorative lights are desired, such as the gutters of a residential home. The memory of the coil will tend to distribute the lights evenly, regardless of the length to which the coil is extended. The apparatus 1 may be suspended with standard hangers at desired spacings. One hanger per turn of the coil will produce a straight appearance, fewer hangers will produce a garland effect.

Another apparatus 1 may be plugged into the first, and the display extended to any distance desired, observing standard safety practices with respect to the number of strands of lights connected in series. Once in place, the apparatus is provided with electrical power by inserting the plug 7 into an electrical outlet. When the apparatus is taken down it automatically returns to its retracted position without any possibility of tangling and is ready for storage and reuse.

As shown in FIGS. 4-6, the helical coil can be of various shapes, sizes, and colors.

For example, FIG. 4 shows a device 101 including a helical coil 103 formed of a transparent, flat plastic material, to which lights 105 are held by adhesive, a plug 107 and receptacle 108 extending beyond the coil 103.

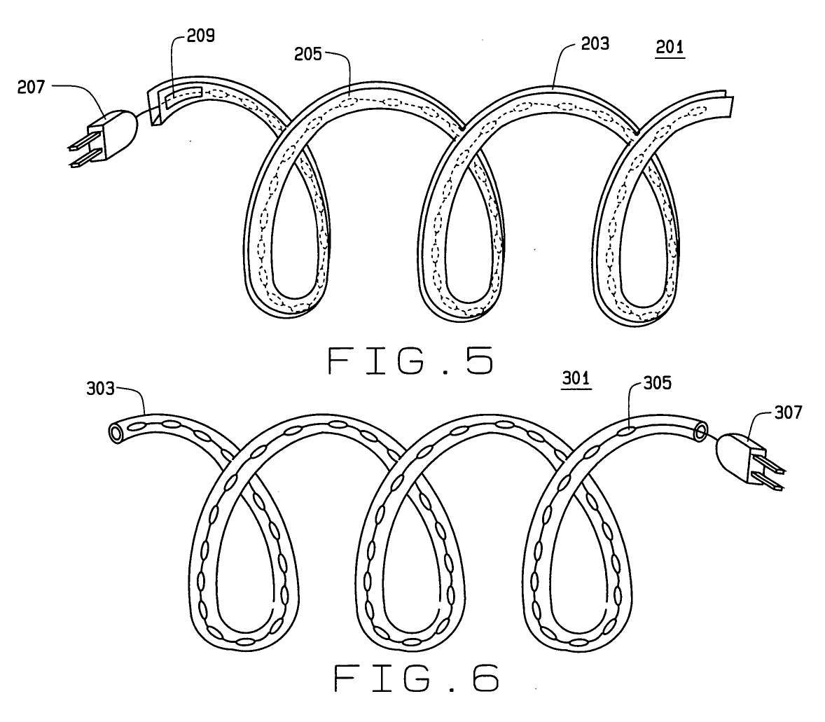

FIG. 5 shows a partial device 201 in which U-shaped channel 203 forms the helical spring coil. The channel 203 frictionally holds the lights 205. Slots 209 at the ends of the channel 203 permit the use of a clip to hold together successive coils.

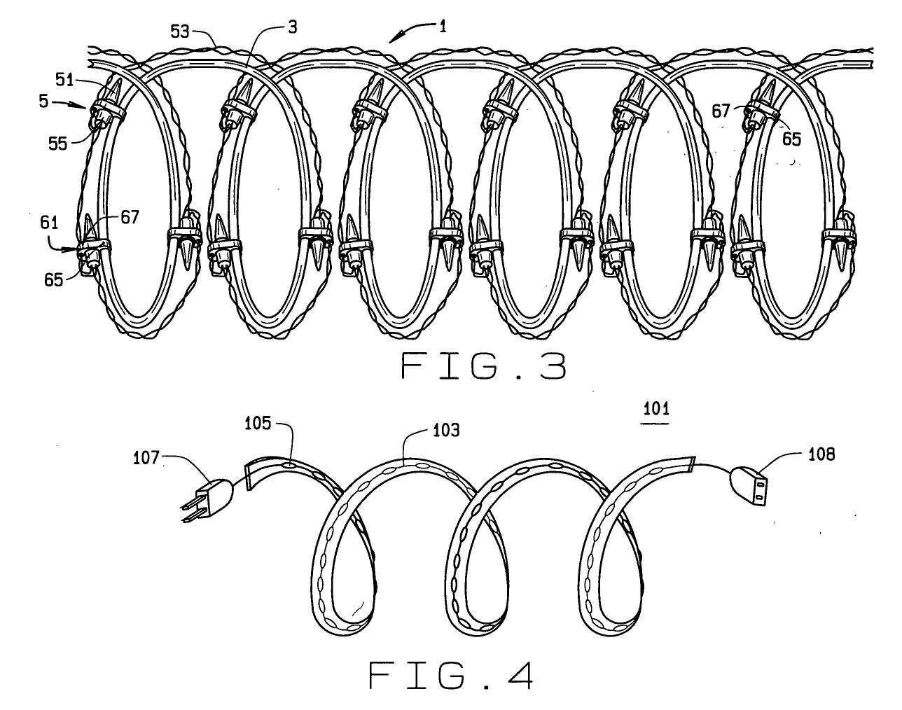

FIG. 6 shows a device 301 having a helical coil 303 that is a clear tube that encapsulates a string of lights 305. The tube 303 may be formed of a transparent or translucent material having a memory which returns it to its coiled form, or it may include a spring insert to provide the memory for the apparatus 301. Because this rope light form of the invention somewhat obscures the bulbs, and because it does not permit easy replacement of bulbs, it is not presently preferred. The rope-light hanger of Adams, U.S. Pat. No. 6,644,836, for example, may be used for connecting and hanging the ends of successive sections of the apparatus 301 in end-to-end relationship, as shown in FIGS. 3 and 4 of that patent.

The helical coil 3, 103, 203, or 303 can be made of any number of different materials, such as polymers or metal, that have sufficient memory to return the coil to a greatly reduced length when its ends are released. Such materials are well known in the art. Reference may be made, for example, to Reum, U.S. Pat. No. 4,120,929. The coil 3, 103, or 203 can be any color ranging from metallic to clear to fluorescent and glow-in-the dark. Multiple coils may be provided, if desired, as illustrated for example in Perlsweig, U.S. Pat. No. 5,692,737. Additional reflective or decorative elements may be included in the apparatus, such as plastic down or tinsel, to increase the apparent size and interest of the bulbs 51.

Although it is preferred that the helical coil 3 have sufficient memory that the apparatus returns substantially to its original axial dimension when released, it will be understood by those skilled in the art that so long as it retains a generally helical shape when released it can be pushed back into a compact shape without danger of tangling the string of lights it carries.

Although attaching the apparatus to a standard electrical outlet is preferred, it is also possible for it to be powered by other sources, such as a battery.

As various other changes could be made in the above constructions without departing from the scope of the invention, it is intended that all matter contained in the above description or shown in the accompanying drawings shall be interpreted as illustrative and not in a limiting sense. All patents referenced herein are hereby incorporated by reference.

1. A retractable light apparatus comprising:
a plug for receiving electrical power;
a helical coil that can elongate and retract to its original shape when released; and decorative lights affixed to the helical coil.

2. A retractable light apparatus as in claim 1 wherein the helical coil comprises a flexible tube encapsulating the decorative lights.

3. A retractable light apparatus as in claim 1 wherein the helical coil comprises a channel encapsulating the helical coil of decorative lights.

4. A retractable light apparatus as in claim 1 further comprising a connector adapted for securing the apparatus to another such apparatus.

5. A retractable light apparatus as in claim 4 wherein the connector is formed from the coil.

6. A retractable light apparatus as in claim 4 wherein the connector comprises a decorative element.

7. A retractable light apparatus as in claim 1 wherein the helical coil comprises a channel encapsulating the decorative lights.

8. A retractable light apparatus as in claim 1 wherein the apparatus has a fully extended length at least four times as long as its length when relaxed.

9. A retractable light apparatus as in claim 8 wherein the apparatus has a fully extended length of from about four to about sixty feet and a relaxed length of from about one inch to about sixty inches.

10. A retractable light apparatus as in claim 1 wherein the apparatus has a fully extended length of from about eight feet to about twenty-four feet and a relaxed length of from about four inches to about twenty inches.

11. A method of making decorative lights comprising forming a strand of lights into a helical coil having a memory, the coil having an axial length in a relaxed position which is less than four times as long as its axial length in an extended position, the coil returning to substantially its relaxed position when released.

12. A method of installing decorative lights comprising attaching one end of the apparatus of claim 1 to a support and thereafter attaching an opposite end of the apparatus at a distance more than four times the relaxed length of the apparatus.

13. A retractable light apparatus comprising a helical coil that can elongate and retract to a generally helical shape when released, and a plurality of decorative lights positioned along a major portion of the helical coil.

14. The apparatus of claim 13 further comprising a plurality of hangers adapted for mounting the apparatus to a support structure.

15. The apparatus of claim 14 further comprising an electrical plug electrically connected to the lights.

16. The apparatus of claim 13 wherein the apparatus can be stretched at least four times its relaxed length.
